(19) United States
(12) Patent Application Publication
(10) Pub. No.: US 2026/0360251 A1
(43) Pub. Date: Nov. 12, 2026

(54) SYSTEMS AND METHODS FOR LIGHT-WEIGHTED TRAFFIC JAM REPORTING

(71) Applicant: TOYOTA MOTOR ENGINEERING & MANUFACTURING NORTH AMERICA, INC., PLANO, TX (US)

(72) Inventors: YI-CHUNG SU, Canton, MI (US); CHEN-HAN LIN, Ann Arbor, MI (US); KEXUAN ZHAI, Ann Arbor, MI (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 19/204,297

(22) Filed: May 9, 2025

(51) Int. Cl. G08G 1/01; G08G 1/052; G08G 1/0967; G08G 1/0968

(52) U.S. Cl. CPC G08G 1/0133; G08G 1/0112; G08G 1/0145; G08G 1/052; G08G 1/096725; G08G 1/096844

(57) ABSTRACT

Systems and methods are provided for light-weighted traffic jam reporting. An example system may determine a speed of one or more detected vehicles as an ego vehicle and the one or more detected vehicles traverse a road segment. The system may further determine that a traffic jam event is occurring at a location of the ego vehicle based on a magnitude of difference between the determined speed of the one or more detected vehicles and a speed limit of the road segment. The system may further publish, to a remote broker using a publish/subscribe protocol, a message indicating the location of the vehicle and the determination that the traffic jam event is occurring at the location of the vehicle.

### TECHNICAL FIELD

The present disclosure relates generally to automotive systems and technologies. More particularly, some aspects relate to systems and methods for light-weighted traffic jam reporting.

### DESCRIPTION OF RELATED ART

Routing systems for vehicles, such as GPS navigation systems, may generate/determine a route for a vehicle through a road network to get to a destination location. In many cases, a routing system will generate/determine a route that minimizes/reduces travel time based on traffic conditions of the road network.

### BRIEF SUMMARY OF THE DISCLOSURE

According to various embodiments of the presently disclosed technology, a vehicle may include one or more processors and memory storing machine-readable instructions that, when executed by the one or more processors, cause the vehicle to: determine a speed of one or more detected vehicles as the vehicle and the one or more detected vehicles traverse a road segment; determine that a traffic jam event is occurring at a location of the vehicle based on a magnitude of difference between the determined speed of the one or more detected vehicles and a speed limit of the road segment; and publish, to a remote broker using a publish/subscribe protocol, a message indicating: (i) the location of the vehicle; and (ii) the determination that the traffic jam event is occurring at the location of the vehicle.

According to various embodiments of the presently disclosed technology, a method may include determining, by an ego vehicle, a speed of one or more detected vehicles as the ego vehicle and the one or more detected vehicles traverse a road segment; determining, by the ego vehicle, that a traffic jam event is occurring at a location of the ego vehicle based on a magnitude of difference between the determined speed of the one or more detected vehicles and a speed limit of the road segment; and publishing, by the ego vehicle and to a remote broker using a publish/subscribe protocol, a message indicating: (i) the location of the ego vehicle; and (ii) the determination that the traffic jam event is occurring at the location of the ego vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict example embodiments.

FIG. 1 illustrates an example vehicle, in accordance with various embodiments of the presently disclosed technology.

FIG. 2 illustrates example vehicles traversing an example road segment, in accordance with various embodiments of the presently disclosed technology.

FIG. 3 illustrates an example implementation of a traffic jam reporting system, in accordance with various embodiments of the presently disclosed technology.

FIG. 4 illustrates an example process for light-weighted traffic jam reporting, in accordance with various embodiments of the presently disclosed technology.

FIG. 5 illustrates an example computing component that may be used to implement various features of embodiments described in the present disclosure.

The figures are not exhaustive and do not limit the present disclosure to the precise form disclosed.

### DETAILED DESCRIPTION

As described above, routing systems for vehicles may consider traffic conditions when generating/determining a route for a vehicle through a road network to a destination location.

Existing routing systems for vehicles may rely on traffic data (which may also be referred to as dynamic content) that is provided by third-party vendors (i.e., entities that are not owned/operated by a manufacturer of a respective vehicle). For example, a vehicle that is manufactured by company A may have a routing system that receives traffic data that is generated by company B. However, to generate and provide the traffic data, company B may require vehicle/driver data from company A such as vehicle speed, location, heading, vehicle identifying information, etc. For example, the vehicle/driver data may be transmitted from respective vehicles to server(s) of company B, or first to server(s) of company A and then to the server(s) of company B. Company B may analyze this raw vehicle/driver data to determine traffic conditions and generate the traffic data. Not only does this process require a large amount of bandwidth to transmit the vehicle/driver data from respective vehicles to company B, but it also requires substantial server-side processing to extract traffic conditions from the raw vehicle/driver data. Moreover, this process may introduce privacy concerns and may increase costs for company A and the customers of company A.

Against this backdrop, embodiments of the presently disclosed technology provide improved systems and methods for light-weighted traffic jam reporting. The improved systems and methods may, for example, place the processing burden of determining when traffic jams occur from raw sensor data client-side (i.e., on one or more vehicles) instead of server-side. This may be especially beneficial when dealing with large amounts of vehicles since the processing of the correspondingly large amount of raw sensor data may be distributed across respective vehicles. Moreover, the improved systems and methods may also require less bandwidth because raw sensor data is processed by the respective vehicle that generated the raw sensor data instead of transmitting the raw sensor data to a remote server for processing.

As an example, such a system may be implemented in an ego vehicle. The system may determine a speed of one or more detected vehicles as the ego vehicle and the one or more detected vehicles traverse a road segment. The ego vehicle may include one or more sensors (e.g., a camera, a LiDAR sensor, a RADAR sensor, an ultrasonic sensor, etc.) that detect perception data corresponding to the one or more detected vehicles. For example, the detected perception data may indicate the speed of a respective detected vehicle relative to the ego vehicle. Accordingly, the system may determine the speed of the respective detected vehicle based on the detected perception data and a speed of the ego vehicle. Next, the system may determine that a traffic jam event is occurring at a location of the ego vehicle based on a magnitude of difference between the determined speed of the one or more detected vehicles and a speed limit of the road segment. Thus, the processing burden of determining when a traffic jam event has occurred is placed on the system/ego vehicle. The system may subsequently publish, to a remote broker using a publish/subscribe protocol, a message indicating (i) the location of the ego vehicle, and (ii) the determination that the traffic jam event is occurring at the location of the ego vehicle. Publishing the message to the remote broker may require less bandwidth relative to the existing systems discussed above since the message indicates the ego vehicle's determination of the occurrence and location of the traffic jam event instead of including all the raw data that would be required to make the determination of the occurrence and location of the traffic jam event.

Moreover, by utilizing the publish/subscribe protocol, the system may further reduce required bandwidth. For example, a lightweight publish/subscribe protocol such as MQTT may be utilized to publish the message to the remote broker. The remote broker may publish the received message to other vehicles such that the other vehicles may have real-time traffic jam information for navigation route planning. The remote broker may aggregate messages from and distribute the messages (e.g., as traffic jam event data) to multiple vehicles. Utilizing the lightweight publish/subscribe protocol and client-side/vehicle-side processing of data may also enhance security and privacy because little to no identifying information is provided by respective vehicles relative to the existing systems discussed above.

The presently disclosed systems and methods can also be incorporated into, and thus improve, related technological systems.

For example, the presently disclosed systems and methods may be incorporated into (or otherwise integrate/interoperate with) autonomous driving systems to control vehicles along routes. For example, a vehicle may receive traffic jam event data from the remote broker, with an autonomous driving system or navigation system of the vehicle determining or updating a route of the vehicle based on the received traffic jam event data and the autonomous driving system controlling the vehicle along the determined or updated route. As such, the presently disclosed systems and methods can improve the function/operation of the autonomous driving systems by minimizing/reducing the negative impacts of traffic congestion. In turn, this can lead to safer operation of autonomous driving systems, and thus increase safety and efficiency for an entire road network.

Systems and methods are described in greater detail in conjunction with the following figures.

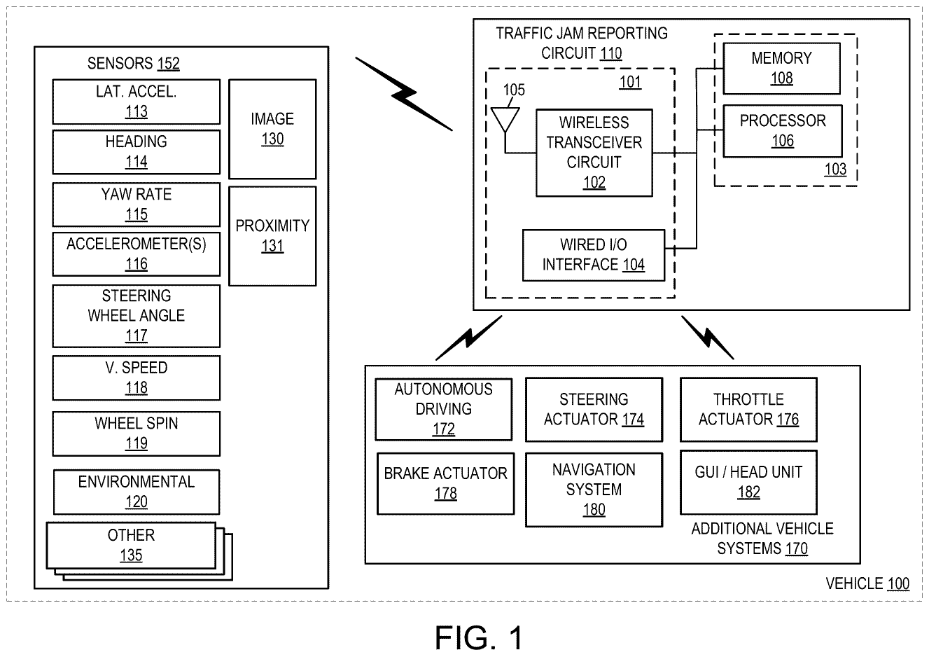

FIG. 1 illustrates an example vehicle 100, in accordance with various embodiments of the presently disclosed technology.

As depicted, vehicle 100 comprises a traffic jam reporting circuit 110, sensors 152, and additional vehicle systems 170. Sensors 152 and additional vehicle systems 170 can communicate with the traffic jam reporting circuit 110 via a wired or wireless communication interface. Although sensors 152 and additional vehicle systems 170 are depicted as communicating with traffic jam reporting circuit 110, they can also communicate with each other. Traffic jam reporting circuit 110 can be implemented as an electronic control unit (ECU) or as part of an ECU. In other embodiments, traffic jam reporting circuit 110 can be implemented independently of an ECU.

In the specific example of FIG. 1, traffic jam reporting circuit 110 includes a communication circuit 101 and a decision circuit 103 (including a processor 106 and a memory 108). Components of traffic jam reporting circuit 110 are illustrated as communicating with each other via a data bus, although other interfaces can be included.

Processor 106 can include one or more general processing units (GPUs), central processing units (CPUs), microprocessors, or any other suitable processing system. Processor 106 may include a single core processor or multicore processors. Memory 108 can be made up of one or more modules of one or more different types of memory (e.g., flash, RAM, etc.) that may be used to store data related to traffic jam detection algorithms, data related to determining a speed of a detected vehicle, statistical model parameters, thresholds, instructions and variables for processor 106, as well as any other suitable information.

Although the example of FIG. 1 is illustrated using processor and memory circuitry, in various embodiments decision circuit 103 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up traffic jam reporting circuit 110.

Communication circuit 101 can utilize a wireless transceiver circuit 102 with an associated antenna 105 for wireless communication. Communication circuit 101 can also utilize a wired I/O interface 104 with an associated hardwired data port (not illustrated). As this example illustrates, communications with traffic jam reporting circuit 110 can include either or both wired and wireless communications. Wireless transceiver circuit 102 can include a transmitter and a receiver to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 105 is coupled to wireless transceiver circuit 102 and can be used by wireless transceiver circuit 102 to transmit radio signals wirelessly to wireless equipment and to receive radio signals as well. These radio signals can include information of almost any sort that is sent or received by traffic jam reporting circuit 110 to/from other entities such as sensors 152, additional vehicle systems 170, other vehicles, connected roadside infrastructure, cloud computing entities, remote servers, etc.

Wired I/O interface 104 may include a transmitter and a receiver for hardwired communications with other devices. For example, wired I/O interface 104 can provide a hardwired interface to other components, including sensors 152 and additional vehicle systems 170. Wired I/O interface 104 can communicate with other devices using Ethernet or any of a number of other wired communication protocols whether standardized, proprietary, open, point-to-point, networked or otherwise.

In certain implementations, decision circuit 103 and communication circuit 101 may be used for computation, memory, or communication tasks beyond traffic determination. In some implementations, vehicle 100 may comprise additional processing, memory, or communication resources devoted to these other tasks.

Sensors 152 can include, for example, lateral acceleration sensor(s) 113, heading sensor(s) 114, yaw rate sensor(s) 115, accelerometer(s) 116, steering wheel angle/position sensor(s) 117 (e.g., one or more sensors to detect angle/position of a steering wheel of vehicle 100), and vehicle speed sensor(s) 118 (e.g., one or more sensors to detect speed of vehicle 100). Sensors 152 may also include wheelspin sensor(s) 119 (e.g., one for each wheel), environmental sensor(s) 120 (e.g., to detect weather conditions or other environmental conditions), image sensor(s) 130, proximity sensor(s) 131, and location sensor(s) 132. Other sensors 135 can also be included as may be appropriate for a given implementation of the vehicle 100.

In some embodiments, the image sensor(s) 130 may comprise one or more cameras (e.g., monocular cameras, stereoscopic cameras, RGB cameras, infrared cameras, etc.) configured to obtain image data of an environment surrounding vehicle 100. Such image data can be used to detect/determine a speed limit of a road segment. For example, the image sensor(s) 130 may obtain image data of a speed limit sign positioned along the road segment. In examples, the traffic jam reporting circuit 110 may use one or more image processing techniques to extract the speed limit from the obtained image data of the speed limit sign.

In some embodiments, the proximity sensor(s) 131 may comprise one or more radar, LiDAR, or ultrasound sensors. In addition or alternatively, in examples, the proximity sensor(s) 131 may comprise one or more of the image sensor(s) 130. The proximity sensor(s) 131 may be configured to detect/obtain perception data of one or more detected vehicles in an environment surrounding vehicle 100. For example, the one or more detected vehicles may be vehicles traversing the same road segment as the vehicle 100 such that the one or more detected vehicles are within a detection range of the proximity sensor(s) 131 (e.g., within 20 feet of the vehicle 100, within 50 feet of the vehicle 100, etc.). The perception data may be or include any one or combination of radar data, LiDAR data, image data, ultrasonic data, point cloud data, etc.

Such perception data can be used to detect/determine a respective speed of the one or more detected vehicles. For example, the perception data may indicate the position of a respective detected vehicle over time relative to the vehicle 100. In examples, the traffic jam reporting circuit 110 may detect/determine the speed of the one or more detected vehicles based on the perception data and a speed of the vehicle 100 (which may, e.g., be determined via the vehicle speed sensor(s) 118). In some examples, the traffic jam reporting circuit 110 may detect/determine the speed of the one or more detected vehicles further based on data from one or more of the lateral acceleration sensor(s) 113, heading sensor(s) 114, yaw rate sensor(s) 115, accelerometer(s) 116, steering wheel angle/position sensor(s) 117, wheelspin sensor(s) 119, environmental sensor(s) 120, image sensor(s) 130, other sensors 135, or a navigation system 180 (which is described further below).

In some embodiments, one or more of the sensors 152 may include their own processing capability to compute the results for additional information that can be provided to the traffic jam reporting circuit 110. In other embodiments, one or more of the sensors 152 may be data-gathering-only sensors that only provide raw data to the traffic jam reporting circuit 110. In further embodiments, one or more hybrid sensors may be included that provide a combination of raw data and processed data to the traffic jam reporting circuit 110. The sensors 152 may provide analog outputs, digital outputs, or a combination of both.

Additional vehicle systems 170 can include any number of different vehicle components or subsystems used to control or monitor various aspects of the vehicle 100 and its performance. For example, the additional vehicle systems 170 may include any one or combination of an autonomous driving system 172, a steering actuator 174, a throttle actuator 176, a brake actuator 178, the navigation system 180, and a graphical user interface (GUI)/head unit 182. It may be appreciated that the additional vehicle systems 170/vehicle 100 can include additional vehicles components or subsystems not depicted in FIG. 1.

The navigation system 180 may comprise a global navigation satellite system (GNSS) sensor, a GPS sensor, or other types of vehicle positioning sensors. The navigation system 180 may be configured to generate location information or data for the vehicle 100 and/or location data for landmarks in the environment surrounding the vehicle (e.g., intersections or corners of a road). This vehicle location information or data may comprise approximate coordinates (e.g., latitude, longitude, and altitude) of the vehicle 100's position on the Earth's surface. In examples, the vehicle location information or data may further comprise speed and/or direction/heading information of the vehicle 100. In certain implementations such vehicle location information or data can be used to determine a starting location for a route of the vehicle 100. In examples, the navigation system 180 may generate/determine route(s) for the vehicle 100. For example, the navigation system 180 may generate/determine a route from the vehicle 100's starting location through a road network to get to a destination location.

In certain examples, the GUI/head unit 182 may be implemented as part of an in-vehicle infotainment (IVI) system (IVI systems may deliver entertainment and information to occupants of a vehicle through audio/video interfaces, control elements like touch screen displays, button panels, voice commands, etc.). In addition or alternatively, in examples, the GUI/head unit 182 may be or include either or both of a gauge cluster or a head-up display (HUD) of the vehicle 100. In certain examples the GUI/head unit 182 may be or include one or more liquid crystal display (LCD) screens or other types of screens/displays.

As alluded to above, in examples, the traffic jam reporting circuit 110 may determine that a traffic jam event is occurring at a location of the vehicle 100. A traffic jam event may correspond to a traffic event where the speed of one or more vehicles traversing a road segment is below (or substantially below) a speed limit of the road segment. As an example, the traffic jam reporting circuit 110 may determine that a traffic jam event is occurring at a location of the vehicle 100 based on a magnitude of difference between a determined speed of the one or more detected vehicles and a speed limit of the road segment. The speed of the one or more detected vehicles may be determined via the proximity sensors 131, for example. The location of the vehicle 100 may be determined via the navigation system 180, for example. The speed limit of the road segment may be determined via either or both of the image sensors 130 and the navigation system 180, for example.

As an example, the traffic jam reporting circuit 110 may determine that a traffic jam event is occurring at a location of the vehicle 100 when the determined speed of the one or more detected vehicles is lower than the speed limit by at least a threshold margin. In examples, the threshold margin may be a set number such as five (5) miles per hour (MPH), ten (10) MPH, fifteen (15) MPH, etc. Alternatively, in examples, the threshold margin may be a percentage of the determined speed limit, such as 10%, 15%, 20%, etc. of the determined speed limit. The threshold margin may be stored on the memory 108, for example.

In addition or alternatively, in examples, the traffic jam reporting circuit 110 may determine that a traffic jam event is occurring at the location of the vehicle 100 when the determined speed of a threshold number of the one or more detected vehicles is lower than the speed limit by at least the threshold margin. As an example, in some implementations, if there are three (3) detected vehicles the traffic jam reporting circuit 110 may determine that a traffic jam event is occurring at the location of the vehicle 100 when the speeds of at least two (2) of the three (3) detected vehicles are below the speed limit by at least the threshold margin. Alternatively, in some implementations, the traffic jam reporting circuit 110 may determine that a traffic jam event is occurring at the location of the vehicle 100 when the speeds of all of the detected vehicles are below the speed limit by at least the threshold margin.

In addition or alternatively, in examples, the traffic jam reporting circuit 110 may determine that a traffic jam event is occurring at the location of the vehicle 100 when: (i) the determined speed of the threshold number of the one or more detected vehicles is lower than the speed limit by at least the threshold margin; and (ii) a speed of the vehicle 100 is lower than the speed limit by at least the threshold margin.

In addition or alternatively, in examples, the traffic jam reporting circuit 110 may determine that a traffic jam event is occurring at a location of the vehicle 100 when a determined speed of the vehicle 100 is lower than the speed limit by at least the threshold margin.

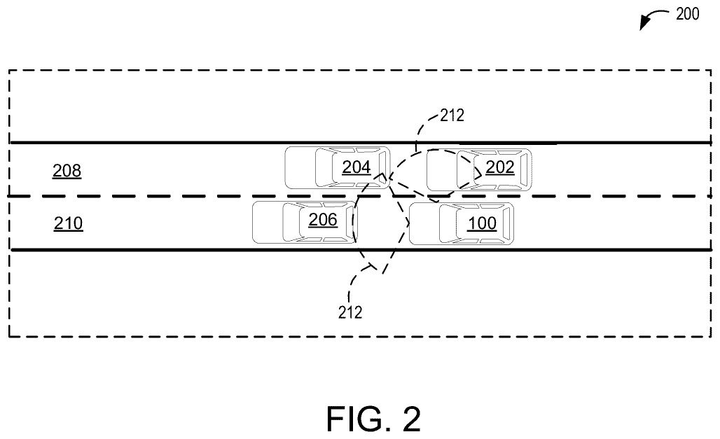

FIG. 2 illustrates the vehicle 100 and one or more detected vehicles traversing a road segment 200. In the example of FIG. 2, the road segment 200 comprises a first lane 210 and a second lane 208 and the one or more detected vehicles comprise a first detected vehicle 202, a second detected vehicle 204, and a third detected vehicle 206. In other examples, the road segment 200 may comprise any number of lanes and the one or more detected vehicles may comprise any number of detected vehicles.

As illustrated in FIG. 2, the vehicle 100 may be positioned in the first lane 210, the third detected vehicle 206 may be positioned in the first lane 210 ahead of the vehicle 100, and the first and second detected vehicles 202, 204 may each be positioned in the second lane 208. As discussed above with reference to FIG. 1, the traffic jam reporting circuit 110 may determine the respective speed of the detected vehicles 202, 204, 206 using the proximity sensor(s) 131 to detect/obtain perception data 212 corresponding to the detected vehicles 202, 204, 206. As an example, the perception data 212 may be data resulting from signals being transmitted to the vehicles 202, 204, 206 by the proximity sensor(s) 131 and being reflected back to the proximity sensor(s) 131.

The traffic jam reporting circuit 110, in some examples, may determine that a traffic jam event is occurring at the location of the vehicle 100 when the determined speed of the third detected vehicle 206 is lower than the speed limit by at least the threshold margin. In addition or alternatively, in examples, the traffic jam reporting circuit 110 may determine that a traffic jam event is occurring at the location of the vehicle 100 when the determined speeds of the third detected vehicle 206 and either or both of the first detected vehicle 202 the second detected vehicle 204 are each lower than the speed limit by at least the threshold margin. Alternatively, in some examples, the traffic jam reporting circuit 110 may determine that a traffic jam event is occurring at the location of the vehicle 100 when the determined speed of the first detected vehicle 202 is lower than the speed limit by at least a threshold margin.

Referring again to FIG. 1, in certain implementations, the traffic jam reporting circuit 110 can provide determined traffic jam event(s) to the navigation system 180. In turn, the navigation system 180 may generate/determine a route or update a route of the vehicle 100 based on the determined jam traffic event(s) (e.g., the route may avoid the determined traffic jam event(s)). The navigation system 180 may display a representation of the route on the GUI/head unit 182 of the vehicle 100. In addition or alternatively, in some examples, the traffic jam reporting circuit 110 can provide the determined traffic jam event(s) to the GUI/head unit 182 to display a representation of the determined traffic jam event(s) (such as, e.g., indicators corresponding to the determined traffic jam event(s) on a digital map).

In some implementations, the navigation system 180 can additionally (or alternatively) provide the generated/determined or updated route to the autonomous driving system 172. In turn, the autonomous driving system 172 can autonomously control the vehicle 100 along the generated/determined or updated route using one or more of the steering actuator 174, the throttle actuator 176, or the brake actuator 178.

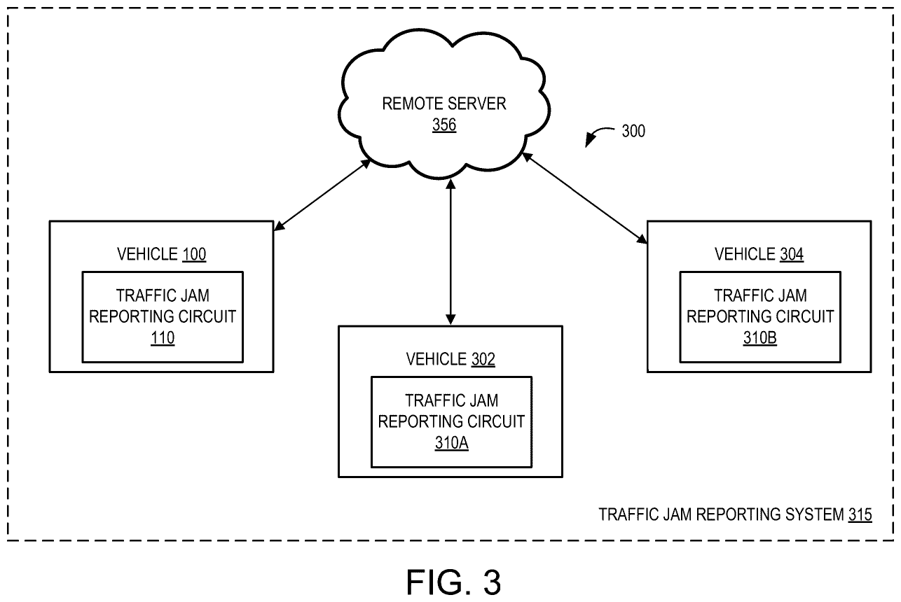

In certain implementations, the traffic jam reporting circuit 110 can additionally (or alternatively) receive, from a remote server/broker (e.g., remote server 356 as shown in FIG. 3), traffic jam event data associated with a route of the vehicle 100. The received traffic jam event data may correspond to one or more traffic jam events that were published to the remote server by one or more other vehicles (e.g., vehicles 302 and 304 shown in FIG. 3). The traffic jam reporting circuit 110 can provide the received traffic jam event data to the navigation system 180 to adjust/update the route of the vehicle 100. In turn, the autonomous driving system 172 can autonomously control the vehicle 100 along the adjusted/updated route using one or more of the steering actuator 174, the throttle actuator 176, or the brake actuator 178. In addition or alternatively, in examples the navigation system 180 may display a representation of the adjusted/updated route on the GUI/head unit 182 of the vehicle 100.

FIG. 3 depicts an example traffic jam reporting system 315, in accordance with various embodiments of the presently disclosed technology.

As depicted in FIG. 3, in some embodiments the traffic jam reporting system 315 may be implemented across a remote server 356 and one or more vehicles traversing a road network, such as vehicle 100 from FIG. 1, vehicle 302, and vehicle 304. Such embodiments may be facilitated by a remote environment 300. In some embodiments, the remove environment 300 may comprise a cloud-based environment. In other embodiments, the remote environment 300 may comprise an edge-based environment. Such an edge-based environment can utilize various types of edge infrastructure, such as roadside/traffic infrastructure, cellular network infrastructure, etc. In some implementations, the remote environment 300 may be a combination of a cloud-based environment and an edge-based environment.

Accordingly, the traffic jam reporting system 315 may include separate instances within one or more entities of the remote environment 300, such as the remote server 356, vehicle 100, vehicle 302, and vehicle 304. In a further aspect, the entities that implement the traffic jam reporting system 315 within the remote environment 300 may vary beyond transportation-related devices and encompass roadside infrastructure elements. Thus, the set of entities that function in coordination with the remote environment 300 may be varied.

In some embodiments, the remote environment 300 itself may comprise a dynamic environment that comprises cloud members that migrate into and out of a geographic area.

The vehicles 302, 304 may include traffic jam reporting circuits 310A, 310B that are the same as or similar to the traffic jam reporting circuit 110 of vehicle 100. In examples, the remote server 356 may comprise a remote broker. The vehicles 100, 302, 304 may communicate with the remote server 356 using a lightweight publish/subscribe protocol, such as MQTT. For example, any of the vehicles 100, 302, 304 may publish messages to the remote server 356. An example message may indicate the location of the respective vehicle and the respective vehicle's determination that a traffic jam event is occurring at the location of the respective vehicle. The remote server 356 may aggregate messages from the vehicles 100, 302, 304 and may distribute messages/traffic jam event data to the vehicles 100, 302, 304. Accordingly, the traffic jam reporting system 315 may comprise a light-weighted traffic jam reporting system.

In examples, the remote server 356 may publish the messages/traffic jam event data to any one or combination of the vehicles 100, 302, 304 at a time interval, such as every thirty (30) minutes, every hour, etc. In some examples, if the remote server 356 receives messages from two different vehicles, such as vehicle 100 and vehicle 302, and the messages indicate traffic jam events that are within a threshold distance from each other (e.g., 0.25 miles, 0.5 miles, one (1) mile, etc.), the remote server 356 will discard one of the messages such that only one of the messages is distributed/published to other vehicles. This may prevent duplicative messages. In some examples, the remote server 356 may alter the threshold distance based on, for example, historical traffic jam data or whether the reported traffic jams are within or close to a large city (e.g., such that closely spaced traffic jam events are expected) or along remote highways. In addition or alternatively, in some examples, the threshold distance and/or the time interval that the remote server 356 publishes messages to the vehicles 100, 302, 304 may be dynamically changed by the remote server 356 based on available bandwidth. For example, when limited bandwidth is available to communicate with the vehicles 100, 302, 304 (or a threshold number of the vehicles 100, 302, 304), the remote server 356 may increase the threshold distance and/or the time interval.

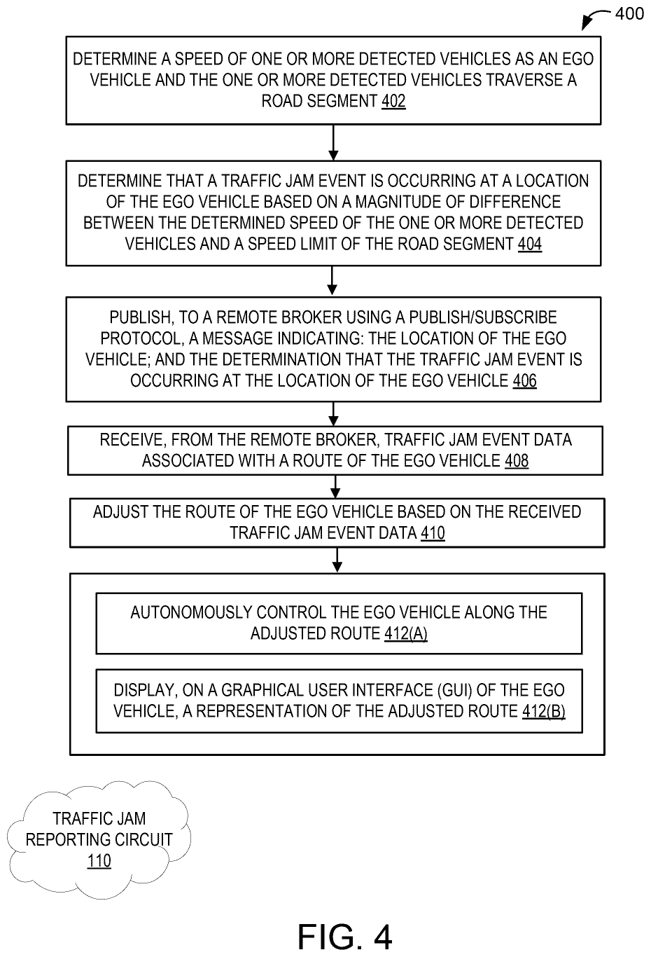

FIG. 4 illustrates an example process 400 that may be performed by traffic jam reporting circuit 110 and/or traffic jam reporting system 315 for light-weighted traffic jam reporting, in accordance with various embodiments of the presently disclosed technology.

As depicted, the traffic jam reporting circuit 110 can perform operation 402 to determine a speed of one or more detected vehicles (e.g., one or more of vehicles 202, 204, 206) as an ego vehicle (e.g., vehicle 100) and the one or more detected vehicles traverse a road segment (e.g., road segment 200).

Based on a magnitude of difference between the determined speed of the one or more detected vehicles and a speed limit of the road segment, the traffic jam reporting circuit 110 can perform operation 404 to determine that a traffic jam event is occurring at a location of the ego vehicle.

In some examples, the ego vehicle may determine that the traffic jam event is occurring at the location of the ego vehicle when the determined speed of a threshold number of the one or more detected vehicles is lower than the speed limit by at least a threshold margin. In addition or alternatively, in some examples, the ego vehicle may determine that the traffic jam event is occurring at the location of the ego vehicle when: (i) the determined speed of the threshold number of the one or more detected vehicles is lower than the speed limit by at least the threshold margin; and (ii) a speed of the ego vehicle is lower than the speed limit by at least the threshold margin.

In some examples, the road segment may comprise a first lane, with the ego vehicle being positioned in the first lane. In such examples, the one or more detected vehicles may comprise a first detected vehicle positioned in the first lane ahead of the vehicle, and the ego vehicle may determine that the traffic jam event is occurring at the location of the ego vehicle when the determined speed of the first detected vehicle is lower than the speed limit by at least a threshold margin. In addition or alternatively, in some examples, the road segment may further comprise a second lane and the one or more detected vehicles further comprise a second detected vehicle positioned in the second lane. In such examples, the ego vehicle may determine that the traffic jam event is occurring at the location of the ego vehicle when the determined speeds of the first detected vehicle and the second detected vehicle are each lower than the speed limit by at least the threshold margin.

In some examples, the road segment may comprise a first lane and a second lane, with the ego vehicle being positioned in the first lane, and the one or more detected vehicles may comprise a first detected vehicle positioned in the second lane. In such examples, the ego vehicle may determine that the traffic jam event is occurring at the location of the ego vehicle when the determined speed of the first detected vehicle is lower than the speed limit by at least a threshold margin.

The traffic jam reporting circuit 110 can perform operation 406 to publish, to a remote broker using a publish/subscribe protocol, a message indicating: (i) the location of the ego vehicle; and (ii) the determination that the traffic jam event is occurring at the location of the ego vehicle.

In some examples, the process 400 may include the traffic jam reporting circuit 110 performing operation 408 to receive, from the remote broker, traffic jam event data associated with a route of the ego vehicle. In some examples, the received traffic jam event data may correspond to one or more messages that were published to the remote broker by one or more other vehicles (e.g., vehicles 302, 304).

In some examples, the process 400 may include the traffic jam reporting circuit 110 performing operation 410 to adjust the route of the ego vehicle based on the received traffic jam event data.

As depicted, the traffic jam reporting circuit 110 can perform at least one of operations 412(A) or 412(B) in accordance with the adjusted route.

Performing operation 412(A) may involve autonomously controlling the ego vehicle along the adjusted route. Performing operation 412(B) may involve displaying, on a graphical user interface (GUI) of the ego vehicle, a representation of the adjusted route.

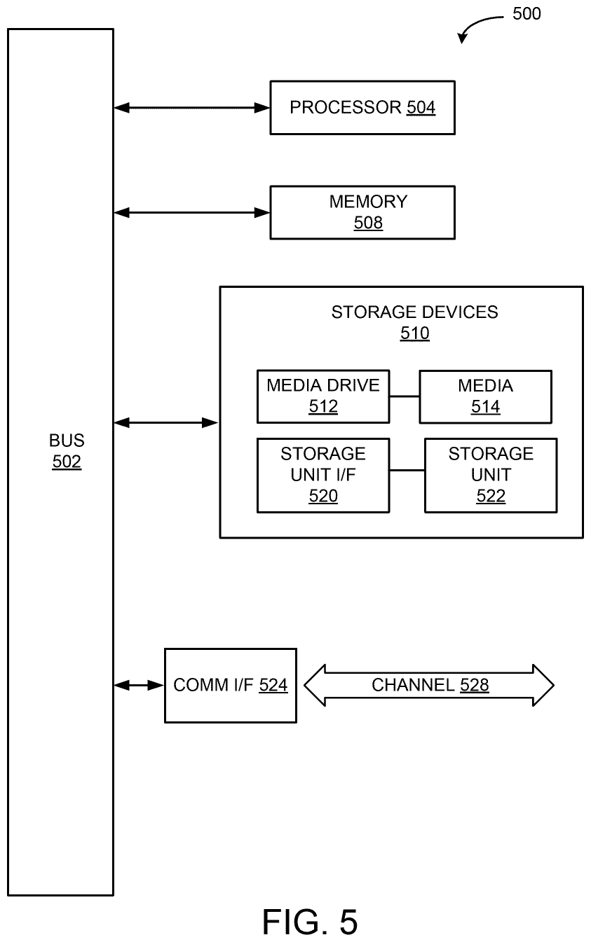

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up a user device, a user system, and a non-decrypting cloud service. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 522, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is target or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle comprising:
one or more processors; and
memory storing machine-readable instructions that, when executed by the one or more processors, cause the vehicle to:
determine a speed of one or more detected vehicles as the vehicle and the one or more detected vehicles traverse a road segment;
determine that a traffic jam event is occurring at a location of the vehicle based on a magnitude of difference between the determined speed of the one or more detected vehicles and a speed limit of the road segment; and
publish, to a remote broker using a publish/subscribe protocol, a message indicating:
the location of the vehicle; and
the determination that the traffic jam event is occurring at the location of the vehicle.

2. The vehicle of claim 1, wherein the vehicle determines that the traffic jam event is occurring at the location of the vehicle when the determined speed of a threshold number of the one or more detected vehicles is lower than the speed limit by at least a threshold margin.

3. The vehicle of claim 2, wherein the vehicle determines that the traffic jam event is occurring at the location of the vehicle when:
the determined speed of the threshold number of the one or more detected vehicles is lower than the speed limit by at least the threshold margin; and
a speed of the vehicle is lower than the speed limit by at least the threshold margin.

4. The vehicle of claim 1, wherein:
the road segment comprises a first lane, the vehicle being positioned in the first lane;
the one or more detected vehicles comprise a first detected vehicle positioned in the first lane ahead of the vehicle; and
the vehicle determines that the traffic jam event is occurring at the location of the vehicle when the determined speed of the first detected vehicle is lower than the speed limit by at least a threshold margin.

5. The vehicle of claim 4, wherein:
the road segment further comprises a second lane;
the one or more detected vehicles further comprise a second detected vehicle positioned in the second lane; and
the vehicle determines that the traffic jam event is occurring at the location of the vehicle when the determined speeds of the first detected vehicle and the second detected vehicle are each lower than the speed limit by at least the threshold margin.

6. The vehicle of claim 1, wherein:
the road segment comprises a first lane and a second lane, the vehicle being positioned in the first lane;
the one or more detected vehicles comprise a first detected vehicle positioned in the second lane; and
the vehicle determines that the traffic jam event is occurring at the location of the vehicle when the determined speed of the first detected vehicle is lower than the speed limit by at least a threshold margin.

7. The vehicle of claim 1, wherein the instructions further comprise instructions that, when executed by the one or more processors, cause the vehicle to:
receive, from the remote broker, traffic jam event data associated with a route of the vehicle;
adjust the route of the vehicle based on the received traffic jam event data; and
at least one of:
autonomously control the vehicle along the adjusted route; or
display, on a graphical user interface (GUI) of the vehicle, a representation of the adjusted route.

8. The vehicle of claim 7, wherein the received traffic jam event data corresponds to one or more messages that were published to the remote broker by one or more other vehicles.

9. The vehicle of claim 1, further comprising one or more sensors to detect perception data corresponding to the one or more detected vehicles; and
wherein determining the speed of the one or more detected vehicles is based on a speed of the vehicle and the detected perception data.

10. The vehicle of claim 9, wherein the one or more sensors comprise at least one of:
a camera;
a LiDAR sensor;
a radar sensor; or
an ultrasonic sensor.

11. A method comprising:
determining, by an ego vehicle, a speed of one or more detected vehicles as the ego vehicle and the one or more detected vehicles traverse a road segment;
determining, by the ego vehicle, that a traffic jam event is occurring at a location of the ego vehicle based on a magnitude of difference between the determined speed of the one or more detected vehicles and a speed limit of the road segment; and
publishing, by the ego vehicle and to a remote broker using a publish/subscribe protocol, a message indicating:
the location of the ego vehicle; and
the determination that the traffic jam event is occurring at the location of the ego vehicle.

12. The method of claim 11, wherein the ego vehicle determines that the traffic jam event is occurring at the location of the ego vehicle when the determined speed of a threshold number of the one or more detected vehicles is lower than the speed limit by at least a threshold margin.

13. The method of claim 12, wherein the ego vehicle determines that the traffic jam event is occurring at the location of the ego vehicle when:
the determined speed of the threshold number of the one or more detected vehicles is lower than the speed limit by at least the threshold margin; and
a speed of the ego vehicle is lower than the speed limit by at least the threshold margin.

14. The method of claim 11, wherein:
the road segment comprises a first lane, the ego vehicle being positioned in the first lane;
the one or more detected vehicles comprise a first detected vehicle positioned in the first lane ahead of the ego vehicle; and
the ego vehicle determines that the traffic jam event is occurring at the location of the ego vehicle when the determined speed of the first detected vehicle is lower than the speed limit by at least a threshold margin.

15. The method of claim 14, wherein:
the road segment further comprises a second lane;
the one or more detected vehicles further comprise a second detected vehicle positioned in the second lane; and
the ego vehicle determines that the traffic jam event is occurring at the location of the ego vehicle when the determined speeds of the first detected vehicle and the second detected vehicle are each lower than the speed limit by at least the threshold margin.

16. The method of claim 11, wherein:
the road segment comprises a first lane and a second lane, the ego vehicle being positioned in the first lane;
the one or more detected vehicles comprise a first detected vehicle positioned in the second lane; and
the ego vehicle determines that the traffic jam event is occurring at the location of the ego vehicle when the determined speed of the first detected vehicle is lower than the speed limit by at least a threshold margin.

17. The method of claim 11, further comprising:
receiving, by the ego vehicle and from the remote broker, traffic jam event data associated with a route of the ego vehicle;
adjusting the route of the ego vehicle based on the received traffic jam event data; and
at least one of:
autonomously controlling the ego vehicle along the adjusted route; or
displaying, on a graphical user interface (GUI) of the ego vehicle, a representation of the adjusted route.

18. The method of claim 17, wherein the received traffic jam event data corresponds to one or more messages that were published to the remote broker by one or more other vehicles.

19. The method of claim 11, wherein determining the speed of the one or more detected vehicles is based on a speed of the ego vehicle and perception data detected by one or more sensors of the ego vehicle, the detected perception data corresponding to the one or more detected vehicles.

20. The method of claim 19, wherein the one or more sensors comprise at least one of:
a camera;
a LiDAR sensor;
a radar sensor; or
an ultrasonic sensor.
